(19) United States
(12) Patent Application Publication
(10) Pub. No.: US 2006/0083321 A1
(43) Pub. Date: Apr. 20, 2006

(54) Multi-carrier communication bit-loading in presence of radio-frequency interferers

(76) Inventor: Hossein Sedarat, San Jose, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/086,882

(22) Filed: Mar. 21, 2005

Related U.S. Application Data
(60) Provisional application No. 60/619,355, filed on Oct. 15, 2004.

(51) Int. Cl. H04K 1/10

(52) U.S. Cl. 375/260

(57) ABSTRACT

An apparatus and method of compensating for radio frequency interference (RFI) if present in a tone in a multiple tone system to derive an equivalent noise power that can be used in bit-loading to achieve a better bit rate.

### RELATED APPLICATION

This application claims the benefit of U.S. Provisional Application No. 60/619,355, filed Oct. 15, 2004.

### TECHNICAL FIELD

The invention relates generally to a multi-carrier communication system and, more particularly, to bit-loading in a multi-carrier communication system. BACKGROUND

A multi-carrier communication system, like Discrete Multi-Tone (DMT) in various flavors of a Digital Subscriber Line (e.g. ADSL and VDSL) system, carries information from a transmitter to a receiver over a number of sub-carriers or tones. There are various sources of interference and noise in a multi-carrier system that corrupt the information signal on each tone as it travels through the communication channel and is decoded at the receiver. Because of this signal corruption, the receiver may decode the transmitted data erroneously.

In order to guarantee a reliable communication between transmitter and receiver, each tone can only carry a limited number of data bits. The number of data bits or the amount of information that a tone carries may vary from tone to tone and depends on the relative power of the data-bearing signal and the corrupting signal on that particular tone.

A reliable communication system is typically defined as a system in which the probability of an erroneously detected data bit by the receiver is always less than a target value. The aggregate sources of corruption associated with each tone are commonly modeled as a single noise source with Gaussian distribution that is added to the information signal on that tone. Under these assumptions, the signal-to-noise power ratio (SNR) becomes a significant factor in determining the maximum number of data bits a tone can carry reliably.

The direct relationship between SNR and the bit rate is based on the key assumption of Gaussian distribution for noise. However, this assumption is not completely valid in many practical situations and bit-loading based on that assumption results in either too high or too low bit rate. An important category of such cases is Radio-Frequency Interference (RFI) from sources such as radio transmitters.

In a DMT communication system, data samples on each tone are represented as one of a set of finite number of points in a two-dimensional (2D) Quadrature Amplitude Modulation (QAM) constellation. FIG. 1 illustrates an example scatter plot of a QAM constellation of detected samples. The transmit data in a multi-carrier system is usually represented by a point from a constellation of finite set of possible data points, regularly distributed over a two dimensional space. The set of detected data samples in this example were chosen from a set of 16 data points in a QAM constellation 100. Thus, the QAM constellation grid 100 represents sixteen different possible data values that could be carried by that tone.

The transmitted data point is located at the center of each cell bounded by the decision boundaries 120. For example, a first cell 122 with an expected transmitted data point having coordinates of (−0.5, +0.5). If there is no noise or other sources of error, the received data point will coincide with the transmit point located at the center of each cell bounded by the decision boundaries 120.

The dashed lines indicate decision boundaries 120 for the QAM constellation grid 100 of potential data values. The dots are the received data points. The distance between these points and the center of their corresponding cell is the error of detection.

The center coordinates of a particular cell for example, (−0.5, +0.5) for the first block 122, represent the expected amplitude and phase of the transmitted data for that data point. A transmitted data point within the boundaries of a given cell allows that transmitted data point to be correlated to the data value associated with that cell. However, because of noise error present in the system, the received data point may be decoded with some distance from the expected transmitted point. The distance from the expected transmitted point, for example the center of the first block 122 coordinates −0.5, +0.5, to the actual coordinates of the dots in that cell represent the detection error in the system.

The distance between the detected samples and the actual transmitted data points represents the detection error. The aggregate of all the error points in a 2D plane is known as the scatter plot. The scatter plot for a case of additive white Gaussian noise is shown in FIG. 2a. The scatter plot 200 displays error samples 228 on perpendicular axes with coordinates at the center of the block being the expected amplitude of the transmitted data points. When the source of error is solely an additive white Gaussian noise, then the values of error samples 228 in each direction have a Gaussian distribution. The scatter plot 200 shows the aggregate of error samples for all of the data points in the QAM constellation. The noise source in this plot is a Gaussian noise source of unit power. Each marked point in this plot represents a detected data point at the receiver. The distance of these points from the center shows the detection error. The cluster of error samples 228 at the center has a Gaussian distribution and represents the detection error due to the background noise when there is no interference. The density of error samples decreases as the magnitude of the error sample increases away from the expected transmitted data point.

FIG. 2b illustrates an example histogram representative of the Gaussian distribution of error samples solely from the background noise illustrated in FIG. 2a. The Gaussian distribution of the error samples 230 from solely background noise has the highest amplitude 232 closest to the expected transmitted data point, i.e. coordinates (0,0). The amplitude of the distribution of error samples decreases as the magnitude of the error sample increases away from the expected transmitted data point. The Gaussian distribution of the error samples 230 from solely background noise will have a given power level associated with that Gaussian distribution of the error samples. The Gaussian distribution of the error samples 230 will also have a standard deviation derived 234 from the Gaussian distribution of background noise approximately equal to the square root of the power level.

FIG. 2c illustrates a scatter plot of a QAM constellation of detected error samples in the presence of RFI interference. The scatter plot 250 shows the error introduced to the transmitted training signal due to RF interference and Gaussian background noise combined over time. The overall noise is the sum of the radio-frequency interference (RFI) and the background Gaussian noise. The radio-frequency (RF) signal has constant amplitude (r) and a phase that grows linearly in time. In the scatter plot, the error due to RFI appears as an error point that rotates on a circular trajectory. When it is added to the background Gaussian noise, the RFI causes a ring 258 of error points in the scatter plot. The RF interference shifts the distribution of error points away from the target distribution coordinates of (0,0) to the outer ring 258 to create a shifted Gaussian distribution plot as illustrated in FIG. 2d. Given the phase of RFI signal, the distribution of the error samples has a shifted Gaussian distribution curve 240. The distance between the center point (0,0) and the center point of curve 240 corresponds to the amplitude of the RFI signal (r). Clearly, using a simple Gaussian model with zero average for error samples does not match well in the case of RF interference. A simple noise power measurement in this case over-estimates the effect of noise. Accordingly, conventional bit-loading algorithms that are based on the assumption of a simple Gaussian distribution of noise may not be optimal for use where there is signal contribution due to RF interference.

FIG. 3 illustrates the noise model for combined white-Gaussian noise source and RFI source. The RF interference is an added source of noise with constant amplitude and linearly increasing phase. In FIG. 3, the background Gaussian noise has a power of σ², and the RF interference (RFI) has the amplitude of r and the relative frequency of f. The overall noise power in the presence of both Gaussian and RFI is:
P=σ²+r² (1)

One approach to deal with RFI is to estimate and cancel it. However, RFI estimation and cancellation techniques may be prohibitively too complex for implement and may also suffer from problems related to error propagation.

### BRIEF DESCRIPTION OF THE DRAWINGS

The present invention is illustrated by way of example, and not by way of limitation, in the figures of the accompanying drawings in which:

FIG. 1 illustrates an example scatter plot of a QAM constellation of detected error samples.

FIG. 2a illustrates a scatter plot when noise in a tone is additive white Gaussian noise.

FIG. 2b illustrates an example histogram representative of the Gaussian distribution of error samples solely from the background noise illustrated in FIG. 2a.

FIG. 2c illustrates an example scatter plot of a QAM constellation of detected error samples in the presence of RFI interference.

FIG. 2d illustrates an example histogram representative of the shifted Gaussian distribution of error samples due to the RF interference illustrated in FIG. 2c.

FIG. 3 illustrates the noise model for combined white-Gaussian noise source and RFI source.

FIG. 4 illustrates a block diagram of an embodiment of a discrete multiple tone system.

FIG. 5 illustrates one embodiment of RFI compensation margin as a function of relative power of RFI to total noise.

FIG. 6 illustrates one embodiment of a method of measuring the amplitude of the RFI signal.

FIG. 7 illustrates one embodiment of a receiver of FIG. 4.

FIG. 8 illustrates one embodiment of handling RFI contributions to total noise power present in a tone.

FIG. 9 illustrates one embodiment of a method of determining whether RF interference is present in a tone.

FIG. 10 illustrates one embodiment of a method of compensating for RF interference that is present on a transmission medium for a tone.

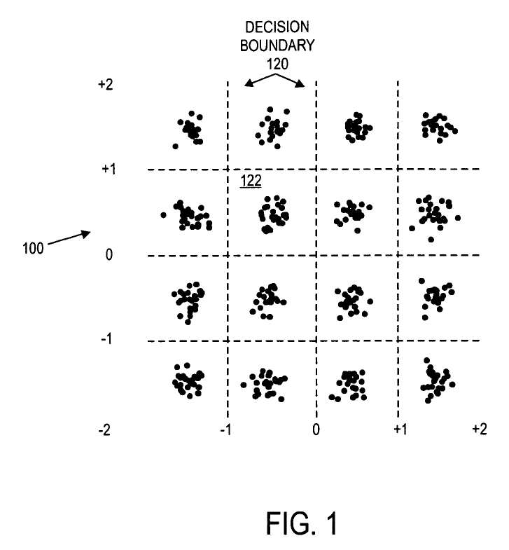

### DETAILED DESCRIPTION

In the following description, numerous specific details are set forth, such as examples of specific commands, named components, connections, number of frames, etc., in order to provide a thorough understanding of the present invention. It will be apparent, however, to one skilled in the art that the present invention may be practiced without these specific details. In other instances, well known components or methods have not been described in detail but rather in a block diagram in order to avoid unnecessarily obscuring the present invention. Thus, the specific details set forth are merely exemplary. The specific details may be varied from and still be contemplated to be within the spirit and scope of the present invention.

The following detailed description includes several modules, which will be described below. These modules may be implemented by hardware components, such as logic, or may be embodied in machine-executable instructions, which may be used to cause a general-purpose or special-purpose processor programmed with the instructions to perform the operations described herein. Alternatively, the operations may be performed by a combination of hardware and software.

In general, a method and apparatus are described for multi-carrier communication bit-loading in the presence of radio-frequency interference. As previously discussed, RF interference is an added source of noise with constant amplitude and linearly increasing phase. In the methods and apparatus described herein, the RFI characteristics of a transmission signal are measured, but the RFI contribution to the signal itself is not cancelled. The information about the RFI contribution to the signal is used in bit-loading in order to achieve a better performance. Such an approach is less complex than a conventional RFI-cancellation approach and does not cause error propagation in the signal detection.

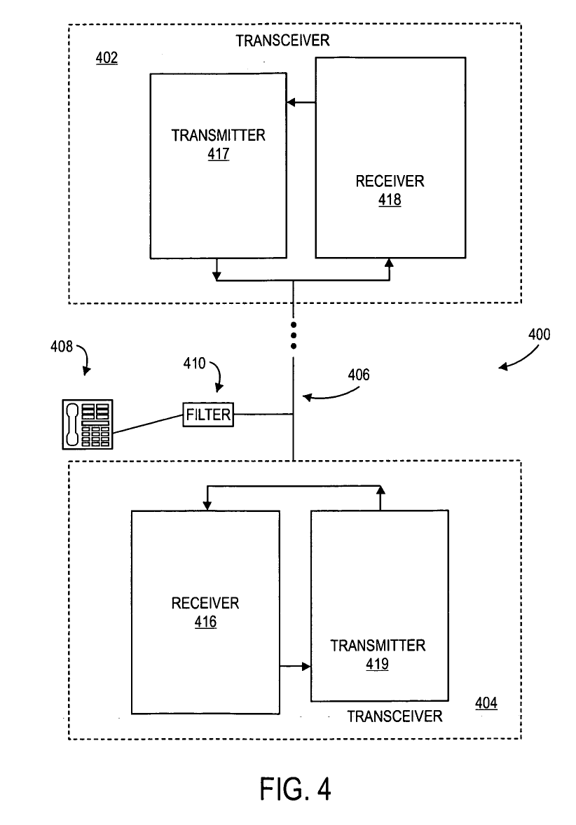

FIG. 4 illustrates a block diagram of an embodiment of a discrete multiple tone system. The discrete multiple tone system 400, such as a Digital Subscriber Line (DSL) based network, may have two or more transceivers 402 and 404, such as a DSL modem in a set top box. In one embodiment, the set top box may be a stand-alone DSL modem. In one embodiment, for example, the set top box employs a DSL mode along with other media components to combine television (Internet Protocol TV or Satellite) with broadband content from the Internet to bring the airwaves and the Internet to an end user's TV set. The multiple carrier communication channel may communicate a signal to a residential home. The home may have a home network, such as an Ethernet. The home network may either use the multiple carrier communication signal, directly, or convert the data from the multiple carrier communication signal. The set top box may also include an integrated Satellite and Digital Television Receiver, High-Definition Digital Video Recorder, Digital Media Server and other components.

The first transceiver 402, such as a Discrete Multi-Tone transmitter, transmits and receives communication signals from the second transceiver 404 over a transmission medium 406, such as a telephone line. Other devices such as telephones 408 may also connect to this transmission medium 406. An isolating filter 410 generally exists between the telephone 408 and the transmission medium 406. A training period occurs when initially establishing communications between the first transceiver 402 and a second transceiver 404.

The discrete multiple tone system 400 may include a central office, multiple distribution points, and multiple end users. The central office may contain the first transceiver 402 that communicates with the second transceiver 404 at an end user's location.

Each transmitter portion 417, 419 of the transceivers 402, 404, respectively, may transmit data over a number of mutually independent sub-channels i.e., tones. Each sub-channel carries only a certain portion of data through QAM of the sub-carrier. The number of information bits loaded on each tone and the size of corresponding QAM constellation may potentially vary from one tone to another and depend generally on the relative power of signal and noise at the receiver. When the characteristics of signal and noise are known for all tones, a bit-loading algorithm may determine the optimal distribution of data bits and signal power amongst sub-channels. Thus, a transmitter portion 417, 419 of the transceivers 402, 404 modulates each sub-carrier with a data point in a QAM constellation.

Each transceiver 402, 404 also includes a receiver portion 418, 416 that contains hardware and/or software to detect for the presence of RFI present in the tones. Each receiver 418, 416 may detect an error as the difference between the received data point in the QAM constellation and the expected transmitted point in the QAM constellation. Each receiver 418, 416 may detect for the presence of RFI based on the detected error. The detection error for each transmitted data point may be known as an error sample.

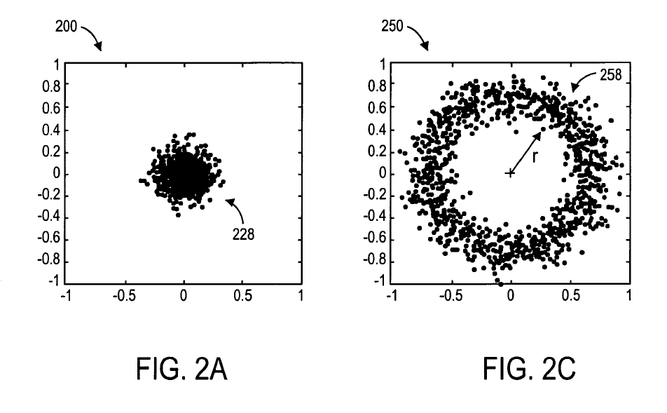

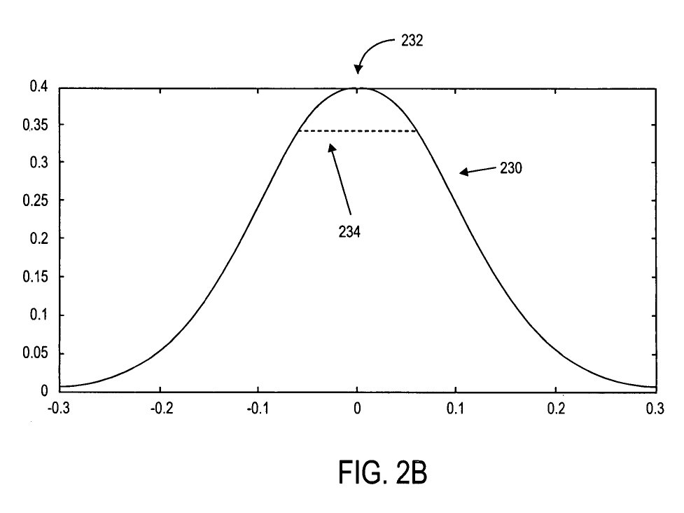

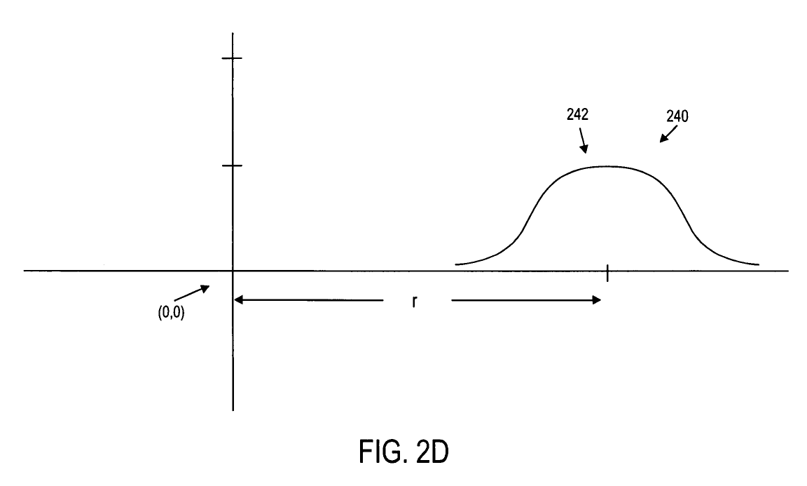

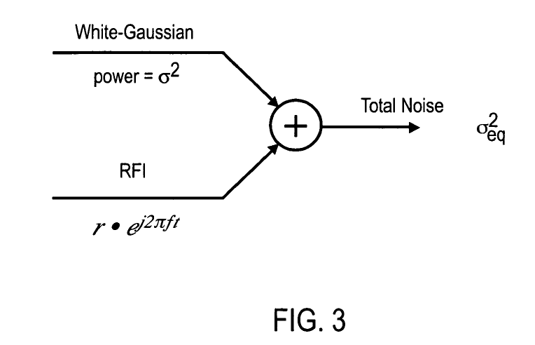

The training protocol may dictate the transmission of long strings of transmitted data points to assist in determining the noise present on the transmission medium. As discussed above, data samples on each tone carried on transmission medium 406 are represented as one of a set of finite number of points in a 2D QAM constellation. These data points are detected at a receiver 418, 416 with some distance from the transmitted point that represents the detection error. RFI, like some other sources of interference, act as a modulating signal that controls the first moment of the background Gaussian noise. The RFI shifts the distribution of error points to create a shifted Gaussian distribution plot as illustrated in FIG. 2d. Given the phase of the RFI signal, the distribution of the error samples has a shifted Gaussian distribution curve. Accordingly, the overall noise source may be considered conditionally Gaussian with non-zero average. In the case of RFI, the magnitude of the average is the amplitude of the RFI signal r. In such cases, the overall noise source can be treated as a simple zero-mean Gaussian with an effective power expressed below.
σ_{eq}²=M_{σ}·σ² (2)

Where M_{σ} is the compensation margin defined as

$${M}_{σ} = {( 1 + \frac{2}{C} \frac{r}{σ} )}^{2} \qquad ( 3 )$$

Where C is a constant and Ca is the minimum distance between constellation points that allow a target bit-error rate. For instance, at a target error rate of 10⁻⁷ for DSL and with no noise margin and coding gain, the value of C is close to 20.5 dB. The equivalent noise expressed above is the power of a pure Gaussian noise source that yields the same bit-error rate (BER) as the overall composite noise. Any bit-loading algorithm designed for Gaussian noise sources is also applicable to Biased-Gaussian noise sources provided that the BER-equivalent SNR, derived from equations (2) and (3), is used in place of the measured SNR.

To compensate for RFI, one has to measure the power of RF interferer. Using that information and also the measurement for total error power, one can derive the compensation margin using equations (1), (2) and (3) as follows:
σ_{eq}²=M_{ρ}·P (4)

Where M_{ρ} is the RFI compensation margin defined as:

$${M}_{p} = {( \sqrt{1 - \frac{{r}^{2}}{P}} + \frac{2}{C} \sqrt{\frac{{r}^{2}}{P}} )}^{2} \qquad ( 5 )$$

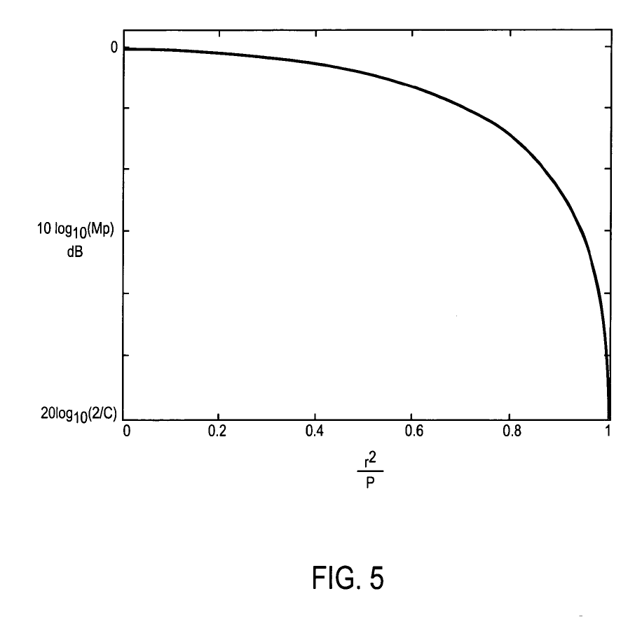

FIG. 5 illustrates how the compensation margin varies with the relative power of the RFI signal to total noise power

$$( \frac{{r}^{2}}{P} ) .$$

The left side of the curve shows 0 dB of compensation margin for a signal having only a Gaussian noise contribution to total noise and the right side of the curve shows a 20Log₁₀(2/C) compensation margin for a signal having only an RFI contribution to total noise.

In order to calculate the compensation margin of equation (5), the amplitude of the RFI signal, r is measured. There are many ways to measure the amplitude of the RFI signal.

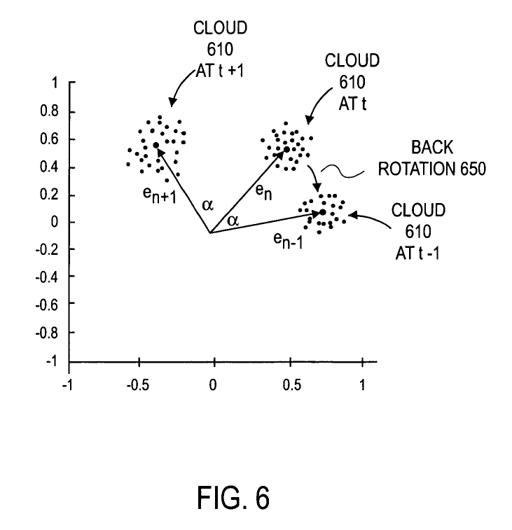

FIG. 6 illustrates one embodiment of a method of measuring the amplitude of the RFI signal. FIG. 6 is a scatter plot showing the error introduced to the transmitted training signal due to RF interference and Gaussian background noise at three points in time. At each point in time (e.g., n−1, n, n+1), the detected error sample is the sum of radio frequency interference and background Gaussian noise and denoted as e.g. eₙ₋₁, eₙ and eₙ₊₁. In this embodiment, the amplitude of the RFI signal may be measured by back-rotating (indicated by curved arrow 650) the error vector of a current measurement eₙ using the error vector of a previous measurement eₙ₋₁. If the current measurements for all the samples are back rotated by the previous measurements, then a single point in 2D is obtained (i.e., all the points lie on top of each other). Since the phase accrual of the error signal due to RFI is constant over a measurement interval, the back-rotation operation 650 would place the error vector at the same angle (α) except for the effect of Gaussian noise. In other words, if Gaussian noise exists on top of the rotation, then back rotation would result in a single point having the cloud of Gaussian error signals (as opposed to the ring illustrated in FIG. 2c). Therefore, by measuring the average amplitude of the back-rotated error vector, the amplitude of the RFI signal can be estimated.

In one embodiment, the following algorithm may be used to calculate the compensation margin:

For each tone t and measurement n, represent the detection error as eₙ(t). This error is a complex number with real and imaginary components:
e(t)=REAL{e(t)}+\sqrt{−1}·IMAG{e(t)}

Calculate the total power of error as:

$$P ( t ) = \frac{1}{N} {\sum }_{n = 1}^{N} {e}_{n} ( t ) \cdot {e}_{n}^{*} ( t ) \qquad ( 6 )$$

where eₙ*(t) is the complex conjugate of the error defined as:
eₙ(t)=REAL{eₙ(t)}−\sqrt{−1}·IMAG{eₙ(t)}

Calculate the RFI power as:

$${r}^{2} ( t ) = \vert \frac{1}{N} {\sum }_{n = 1}^{N} {e}_{n} ( t ) \cdot {e}_{n - 1}^{*} ( t ) \vert \qquad ( 7 )$$

In this equation, the product of error of the current measurement with the complex conjugate of the previous measurement represents the back-rotation operation discussed above. Using the measurements from equations (6) and (7), the equivalent noise power from equations (4) and (5) can be derived. This equivalent noise power can be used in a bit-loading algorithm to obtain a better bit rate as discussed above.

It should be noted that embodiments of the present invention are described below in reference to receiver 416 for ease of discussion, and that receiver 417 may operate in a similar manner as described for receiver 416. Referring again to FIG. 4, receiver 416 may measure the amplitude of the RFI signal, for example, by back-rotating the error vector of the current noise measurement using an error vector of the previous measurement. By calculating the average amplitude of the back-rotated error vector, the amplitude of the RFI signal can be estimated. Receiver 416 may calculate an RFI compensation margin using the estimated power of the RFI signal. The RFI compensation margin may be used to calculate the equivalent noise power that can be used in any bit-loading algorithm designed for Gaussian noise sources as noted above. Bit-loading algorithms designed for Gaussian noise sources are well known in the art; accordingly, a detailed description is not provided.

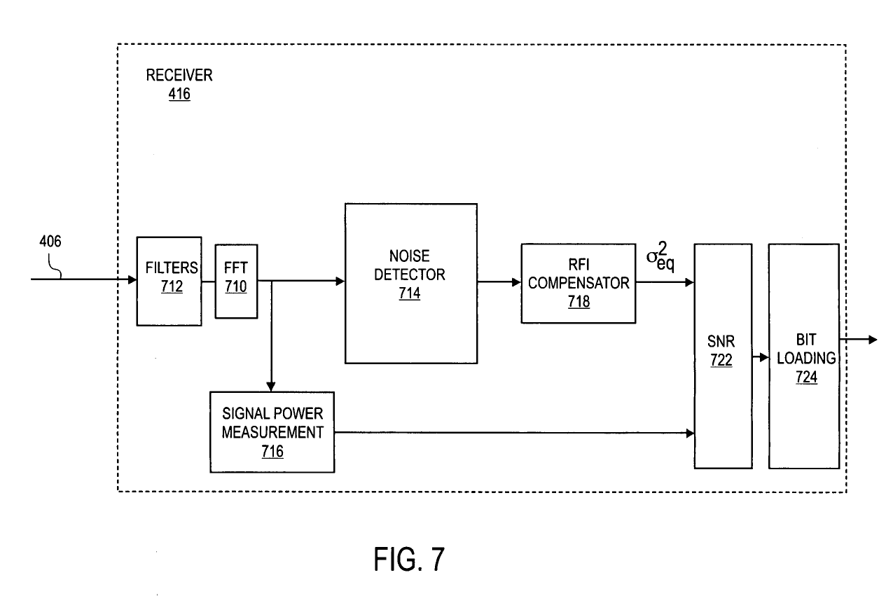

FIG. 7 illustrates one embodiment of a receiver of FIG. 4. In this embodiment, receiver 416 may contain various modules such as a Fast Fourier Transform (FFT) module 710, filters 712, a Noise Power Measurement module 714, Signal Power Measurement module 716, a SNR module 722 and bit-loading module 724. Additional modules and functionality may exist in the receiver 416 that are not illustrated so as not to obscure an understanding of embodiments of the present invention.

In the receiver 416, the data for each tone/sub-channel is typically extracted from the time-domain data by taking the Fourier transform of a block of samples from the multi-tone signal. The Fast Fourier Transform module 710 receives the output of a block of filters 712. The Fast Fourier Transform module 710 transforms the data samples of the multi-tone signal from the time-domain to the frequency-domain, such that a stream of data for each sub-carrier may be output from the Fast Fourier Transform module 710. Essentially, the Fast Fourier Transform module 710 acts as a demodulator to separate data corresponding to each tone in the multiple tone signals. In one embodiment, processing of each sub-carrier may be performed in parallel or in series. The Fast Fourier Transform module 710 may sample a sine and cosine of the amplitude of a tone over time to create the time domain data. The Fourier transform correlates the time domain data of the tone to the actual sine and cosine of the amplitude of the tone over time. The output of the FFT 710 is transmitted to signal power measurement module 716 and noise detector 714.

During a training session, for example, between the transceiver in a central office (e.g., transceiver 402) and the transceiver at an end user's location (e.g., transceiver 404), the transmitter portion (e.g., transmitter 417) of the transceiver in the central office transmits long sequences that include each of these data points. Over time, a large number of samples are collected for each potential data point.

The noise detector measures the amount of noise in a sub carrier signal. For each particular sub-carrier of the multi-carrier signal, the noise detector 714 measures the power level of total noise for that sub-carrier. The noise detector 714 includes a decoder module of expected transmitted data points. The noise detector module 714 measures noise present in the system by comparing the mean difference between the values of the received data to a finite set of expected data points that potentially could be received. The noise in the signal may be detected by determining the distance between the amplitude of the transmitted tone (at a given frequency and amplitude level) and the amplitude of the sine term and cosine term of the received tone to determine the magnitude of the error signal for that tone at that time. The noise present causes the error between the expected known value and the actual received value. The noise detector 714 detects whether RF interference noise is present in the background noise over time. The noise detector 714 may, in effect, generate a scatter plot of noise error over time and analyze the shape of the distribution of the noise error in the scatter plot to determine if RF interference is present.

For each particular sub-carrier of the multi-carrier signal, the noise detector 714 measures the power level of total noise for that sub-carrier including any RF interference. If RF interference is present, then the noise detector 115 triggers the RFI compensation to provide information about the RFI contribution to the signal to bit-loading module 724 to achieve a more optimal bit rate that may be carried by a tone. If RFI noise is present, the RFI compensator 718 generates an equivalent noise power measurement to be used in the SNR calculation and subsequent bit-loading algorithm for that tone.

The Signal Power Measurement module 716 measures the signal power for the sub-carrier, and inputs the result into the SNR module 122. The SNR module 722 determines a signal-to-noise ratio using the equivalent noise power provided by the RFI compensator. The signal-to-noise ratio is provided to bit-loading module 724 to determine bit-loading for all sub-carriers. The bit rate for a tone determined by the bit-loading module may then be transmitted, using transmitter portion 419, to the transceiver 402 (e.g., at a central office) to enable the transmitter 417 of transceiver 402 to know how many bits to use on each tone.

It should be noted that the operations of one or more modules may be incorporated into or integrated with other modules. For example, detection of RFI contributions to noise may be performed by the RFI compensator 718 rather than noise detector 714 or the operations of both modules may be integrated into a single module.

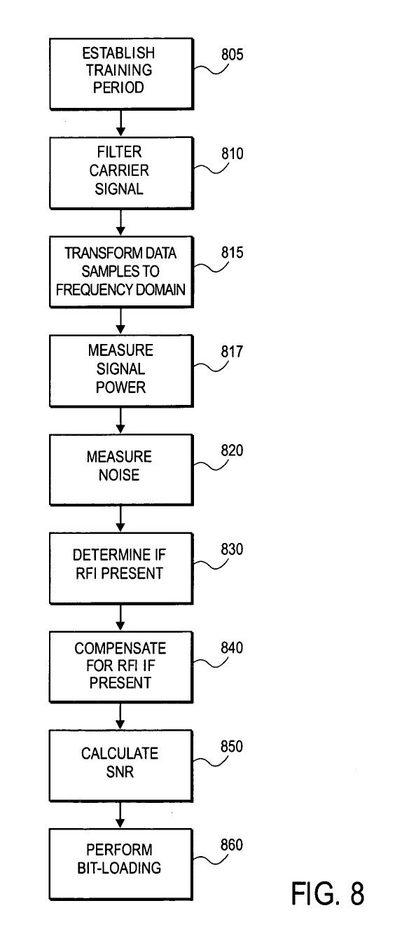

FIG. 8 illustrates one embodiment of handling RFI contributions to total noise power present in a tone. In step 805, a training period between a first transceiver and a second transceiver in the discrete multiple signal carrier system may be established. The multiple carrier signal is passed through filters 712, step 810. The Fast Fourier Transform module 710 receives the output of a block of filters 712 and performs a windowing operation on the multi-tone signal. The FFT module 710 analyses the multiple carrier signals over a defined period time. The defined period of time containing the multiple carrier signals may be referred to as a window or frame of data. The Fast Fourier Transform module 710 transforms the data samples of the multi-tone signal from the time-domain to the frequency-domain, such that a stream of data for each sub-carrier may be output from the Fast Fourier Transform module 710, step 815. In step 817, the signal power for the sub-carrier is measured by Signal Power Measurement module 716.

In step 820, noise detector measures an amount of noise in a sub carrier signal. For each particular sub-carrier of the multi-carrier signal, the noise detector 714 measures the power level of total noise for that sub-carrier.

The method may also include determining whether RFI is present on a transmission medium, step 830, and then, if RFI is present, compensate for the RFI, step 840. In step 850, a signal to noise ratio is calculated using the equivalent noise power measurement of step 840. Then, in step 860, bit-loading may be performed using the signal to noise ratio calculated in step 850 in order to achieve a more optimal bit rate that may be carried by the tone. It should be noted that the modules illustrated in FIG. 8 may be included in other portions of the transceiver 404. For example, the bit-loading illustrated by module 724 may be performed in transmitter portion 419.

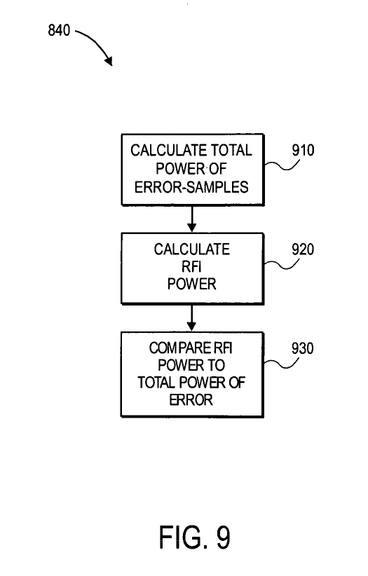

FIG. 9 illustrates one embodiment of a method of determining whether RF interference is present on a tone. In this embodiment, in step 910, the total power of error is calculated, for example, as provided by equation (6) above.

In step 920, the power of the RF interference is calculated. In one embodiment, the amplitude of the RF interference may be calculated by matching the power of a first (e.g., current) error sample to a second (e.g., previous) error sample by placing the phase of each signal in the same reference time, such as by back rotating the phase of each compared error sample, or vector, step 911. By placing the detected error samples into the same reference time, the contribution of Gaussian noise may be effectively eliminated through averaging to provide a measure of the RFI error. The RFI power may be determined using equation (7) above. The product of error of the current measurement with the complex conjugate of the previous measurement represents the back-rotation operation. It should be noted that the calculation of the amplitude of the RF interference may be performed prior to, concurrent with or subsequent to the calculation of total power of error of step 910.

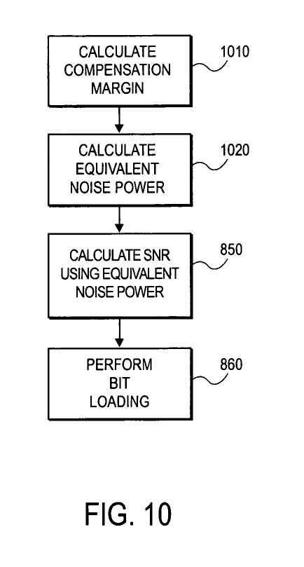

Next, in step 930, a determination is made whether the power of the RF interference is large. If the power of the RF interference is large, then RFI is assumed to be present on the transmission medium and the RFI may be compensated for as discussed below with respect to FIG. 10. In one embodiment, the RF interference may be considered to be large if the RFI power (e.g., r² from equation (7)) is approximately one quarter of the total power of error measured (e.g., P(t) from equation (6)). Alternatively, other thresholds may be used. If so, accordingly, RFI noise may be considered present on the transmission medium for the tone.

If RFI noise is considered to be present on the transmission medium, then the RFI may be compensated as discussed below in relation to FIG. 10. In one embodiment, if there is no RFI present on the line, the calculation of the compensation factor may be composed of setting the compensation factor to zero or de minimis value. Alternatively, a compensation factor may be used independent of detection of RFI. In such an alternative embodiment where RFI detection is not perform, and if there is no RFI present on the line, the calculation of the compensation factor may be composed of setting the compensation factor to zero or de minimis value.

FIG. 10 illustrates one embodiment of a method of compensating for RF interference that is present on a transmission medium for a tone. An equivalent noise power measurement may be generated for use in the SNR calculation and subsequent bit-loading algorithm if RFI is considered to be present. The equivalent noise power is a product of the total power measured and an RFI compensation margin as noted above in equation (4). In step 1010, the compensation margin is calculated using the amplitude of the RFI signal. In one embodiment, the amplitude of the RFI signal is measured by performing a back rotation operation as discussed above and as may be implemented according to equation (7) above. Then, in step 1020, the equivalent noise power measurement is calculated using the compensation margin from step 1010 and the total power of error from step 910, for example, according to equation (4). In step 850, a signal to noise ratio is calculated using the equivalent noise power measurement of step 1020 and used to perform bit-loading, step 860, in order to achieve a more optimal bit rate that may be carried by the tone. It should be noted that the above described steps with respect to FIGS. 8-10 may be repeated for each tone.

The methods described herein may be embodied on a machine-accessible medium, for example, to perform RFI compensation and/or bit-loading. A machine-accessible medium includes any mechanism that provides (e.g., stores and/or transmits) information in a form accessible by a machine (e.g., a computer). For example, a machine-accessible medium includes read only memory (ROM); random access memory (RAM); magnetic disk storage media; optical storage media; flash memory devices; DVD's, electrical, optical, acoustical or other form of propagated signals (e.g., carrier waves, infrared signals, digital signals, EPROMs, EEPROMs, FLASH, magnetic or optical cards, or any type of media suitable for storing electronic instructions. The data representing the apparatuses and/or methods stored on the machine-accessible medium may be used to cause the machine to perform the methods described herein.

Although the RFI compensation methods have shown in the form of a flow chart having separate blocks and arrows, the operations described in a single block do not necessarily constitute a process or function that is dependent on or independent of the other operations described in other blocks. Furthermore, the order in which the operations are described herein is merely illustrative, and not limiting, as to the order in which such operations may occur in alternate embodiments. For example, some of the operations described may occur in series, in parallel, or in an alternating and/or iterative manner.

While some specific embodiments of the invention have been shown the invention is not to be limited to these embodiments. The invention is to be understood as not limited by the specific embodiments described herein, but only by scope of the appended claims.

What is claimed is:

1. A method, comprising:
measuring background Gaussian noise in a tone in a multi-carrier system; and
applying a compensation margin to the background Gaussian noise to obtain an equivalent noise power.

2. The method of claim 1, further comprising:
calculating the compensation margin;
calculating a signal to noise ratio using the equivalent noise power, the equivalent noise power being based on the compensation margin; and
performing bit-loading based on the signal to noise ratio.

3. The method of claim 1, further comprising:
determining if radio frequency interference (RFI) is present in the tone; and
compensating for the RFI if the RFI is determined to be present in the tone.

4. The method of claim 3, wherein determining if RFI is present comprises:
calculating a total power of error samples carried by the tone;
calculating an RFI power of the error samples; and
comparing the RFI power with the total power.

5. The method of claim 1, wherein the compensation margin is substantially zero.

6. The method of claim 4, wherein RFI is determined to be present if the RFI power is approximately greater than one quarter of the total measured error power.

7. The method of claim 4, wherein calculating the total power of error samples comprises averaging a sum of a product of error of a current error sample measurement with a complex conjugate of the current error sample measurement for the error samples.

8. The method of claim 4, wherein calculating the RFI power comprises back rotating a first error vector of a current error sample measurement using a second error vector of a previous error sample measurement.

9. The method of claim 8, wherein back rotating comprises summing a product of a product of error of the current error sample measurement with a complex conjugate of the previous error sample measurement for all of the error samples to generate a summed result.

10. The method of claim 9, wherein back rotating further comprises dividing the summed result by a number of all the error samples to generate an averaged result, and taking an absolute value of the averaged result.

11. The method of claim 1, further comprising:
determining if radio frequency interference (RFI) is present in the tone; and
applying the compensation margin being substantial zero when RFI is determined not to be present in the tone.

12. The method of claim 4, wherein compensating for RFI comprises:
calculating the compensation margin using the total power of error samples and the RFI power; and
calculating the equivalent noise power using the compensation margin and the total power of error samples.

13. The method of claim 8, wherein compensating for RFI comprises:
calculating the compensation margin using the total power of error samples and the RFI power;
calculating the equivalent noise power using the compensation margin and the total power of error samples;
calculating a signal to noise ratio using the equivalent noise power; and
performing bit-loading based on the signal to noise ratio.

14. An article of manufacture, comprising:
a machine-accessible medium including data that, when accessed by a machine, cause the machine to perform operations comprising:
measuring background Gaussian noise in a tone in a multi-carrier system; and
applying a compensation margin to the background Gaussian noise to obtain an equivalent noise power.

15. The article of manufacture of claim 14, wherein the data, when accessed by the machine, cause the machine to perform operations further comprising:
calculating the compensation margin;
calculating a signal to noise ratio using the equivalent noise power, the equivalent noise power being based on the compensation margin; and
performing bit-loading based on the signal to noise ratio.

16. The article of manufacture of claim 14, wherein the data, when accessed by the machine, cause the machine to perform operations further comprising:
determining if radio frequency interference (RFI) is present in a tone in a multi-tone system; and
compensating for the RFI using the compensation margin if the RFI is determined to be present in the tone.

17. The article of manufacture of claim 16, wherein the data, when accessed by the machine, cause the machine to perform operations further comprising:
calculating a total power of error samples carried by the tone;
calculating an RFI power of the error samples; and
comparing the RFI power with the total power.

18. The article of manufacture of claim 14, wherein calculating the RFI power comprises back rotating a first error vector of a current error sample measurement using a second error vector of a previous error sample measurement and wherein the data, when accessed by the machine, cause the machine to perform operations further comprising:
calculating the compensation margin using a total power of error samples carried by the tone and an RFI power of the error samples;
calculating the equivalent noise power using the compensation margin and the total power of error samples;
calculating a signal to noise ratio using the equivalent noise power; and
performing bit-loading based on the signal to noise ratio.

19. An apparatus, comprising:
a multi-tone transceiver to detect data in a multiple tone signal, the transceiver comprising:
a detector module to measure noise power carried by a tone of the multiple tone signal, the detector module to detect for background Gaussian noise in the tone, and
a radio frequency interference (RFI) compensator coupled to the detector module to apply a compensation margin to the background Gaussian noise to obtain an equivalent noise power.

20. The apparatus of claim 19, wherein the detector module is further configured to detect for RFI noise in the tone and wherein the RFI compensator is configured to compensate for the RFI noise when the detector module determines that the RFI noise is present in the tone.

21. The apparatus of claim 20, wherein the RFI compensator is configured to calculate a total power of error samples carried by the tone, calculate a RFI power of the error samples, and compare the RFI power with the total power to determine whether RFI noise is present in the tone.

22. The apparatus of claim 21, wherein the RFI compensator is configured to calculate the RFI power by back rotating a first error vector of a current error sample measurement using a second error vector of a previous error sample measurement.

23. The apparatus of claim 21, wherein the RFI compensator is configured to calculate a compensation margin using the total power of error samples and the RFI power, and calculate the equivalent noise power using the compensation margin and the total power of error samples.

24. The apparatus of claim 23, wherein the transceiver further comprises:
a signal-to-noise (SNR) ratio module coupled to the RFI compensator to calculate a signal-to-noise ratio using the equivalent noise power; and
a bit-loading module coupled to the SNR module to determine a bit rate for the tone based on the signal-to-noise ratio.

25. The apparatus of claim 23, wherein the transceiver is configured to transmit information about the bit rate to another transceiver.

26. A set top box employing a digital subscriber line modem comprising the apparatus of claim 24.

27. A set top box employing a digital subscriber line modem comprising the apparatus of claim 19.

28. An apparatus, comprising:
means for measuring background Gaussian noise in a tone in a multi-carrier system; and
means for applying a compensation margin to the background Gaussian noise to obtain an equivalent noise power.

29. The apparatus of claim 28, further comprising:
means for determining if radio frequency interference (RFI) is present in a tone in the multiple tone system; and
means for compensating for the RFI using the compensation margin if the RFI is determined to be present in the tone.

30. The apparatus of claim 29, further comprising:
means for calculating a total power of error samples carried by the tone;
means for calculating an RFI power of the error samples; and
means for comparing the RFI power with the total power.

31. The apparatus of claim 30, wherein the means for calculating the RFI power comprises means for back rotating a first error vector of a current error sample measurement using a second error vector of a previous error sample measurement and wherein apparatus further comprises:
means for calculating a compensation margin using the total power of error samples and the RFI power;
means for calculating an equivalent noise power using the compensation margin and the total power of error samples;
means for calculating a signal to noise ratio using the equivalent noise power; and
means for performing bit-loading based on the signal to noise ratio.
